(19) United States
(12) Patent Application Publication
(10) Pub. No.: US 2016/0144357 A1
(43) Pub. Date: May 26, 2016

(54) APPARATUSES WITH PRE-PACKAGED REAGENTS

(71) Applicant: Shaoxing PushKang Biotechnology CO., LTD, Shaoxing City (CN)

(72) Inventors: CHIA-HUI LIN, Shaoxing City (CN); YI-FENG YANG, Shaoxing City (CN); BO YU, Shaoxing City (CN)

(21) Appl. No.: 14/801,812

(22) Filed: Jul. 16, 2015

(30) Foreign Application Priority Data
Nov. 20, 2014 (CN) 201410667075.5

(51) Int. Cl. B01L 3/00

(52) U.S. Cl. CPC B01L 3/5027; B01L 2300/0803; B01L 2200/16; B01L 2300/0672; B01L 2300/12; B01L 2300/044; B01L 2400/0409; B01L 2300/047

(57) ABSTRACT

Apparatuses with pre-packaged reagents comprise a reagent package and a protrusion member. More particularly, the reagent package comprises a base and a cover layer, in which the base further comprises at least one pocket. Each pocket is configured to store a reagent, and the cover layer is configured on the at least one pocket to seal the at least one pocket. The protrusion member further comprises an opening and is configured at an injection site, in which the injection site is on each storage chamber disposed on a microfluidic disc. Furthermore, the configuration of the pockets on the base is in accordance with the configuration of the protrusion members. Therefore, the protrusion members would punch through the pockets once the protrusion members are aligned and combined to the pockets. And the following rotation of the microfluidic disc would generate centrifugal force and sequentially release reagents into storage chambers.

### CROSS-REFERENCE TO RELATED APPLICATION AND CLAIM OF PRIORITY

This application claims the benefit of Chinese Patent Application No. 201410667075.5, filed on Nov. 20, 2014, in the State Intellectual Property Office of the People's Republic of China, the disclosure of which is incorporated herein in its entirety by reference.

### 1. TECHNICAL FIELD

At least one embodiment of the present invention relates to apparatus with pre-packaged reagents. More particularly, the apparatus with pre-packaged reagents sequentially releases reagents into the microfluidic disc with the elevating rotational speed.

### 2. DESCRIPTION OF THE RELATED ART

Packages for reagents on the market are various, such as large-sized single packs, small-sized multi-packs, small-sized single packs, and reagent kits. However, no matter the tests are involved with two or more reagents, the reagents in all of these packages are required to be injected individually. The repeated injection procedure takes time to complete, especially when the tests are associated with microfluidic device which usually comprises multiple copies of microfluidic channels. Moreover, the large-sized single pack each contains only one reagent at a time. After several times of use, the reagent in the pack may be contaminated or denatured, and results in failed experiments such as false or inaccurate results.

### SUMMARY

Reagents in packages available on the market required repeated procedures to be transferred to multiple copies of microfluidic channels. These packages do not provide mechanisms to simultaneously transfer multiple reagents to storage chambers on microfluidic channels. Furthermore, reagents in these packages may be contaminated or denatured after several times of use. Accordingly, at least one embodiment of the present invention relates to an apparatus with pre-packaged reagents. The apparatus with pre-packaged reagents contains multiple reagents and provides a mechanism to transfers the multiple reagents simultaneously. Furthermore, the apparatus with pre-packaged reagents also provides mechanisms to sequentially release the reagents to the storage chambers on the microfluidic channels with the increasing rotational speed. The apparatus with pre-packaged reagents may be discarded with the microfluidic disc as a whole, and this disposability of the apparatus with pre-packaged reagents may provide convenience and mitigate possible pollution to the environment. The one-time-use feature of the apparatus with pre-packaged reagents may also diminish contamination and denaturation of reagents, and therefore provides stable and reliable test results.

At least one embodiment of the present invention provides an apparatus comprising a reagent package and a protrusion member. The reagent package comprises a base and a cover layer, in which the base further comprises at least one pocket configured to store a liquid reagent. The cover layer is disposed on the at least one pocket to seal the at least one pocket. In contrast, the protrusion member comprises an opening and is configured at each injection site on a microfluidic disc. More particularly, the injection site is located at each storage chamber on each microfluidic channel on the microfluidic disc.

The positions of pockets on the base are in accordance with the positions of protrusion members. The pockets may be disposed at different radial distances relative to the center of the base. Once the protrusion members are aligned to the pockets and the reagent package is combined to the microfluidic disc, the protrusion members will punch through the cover layer. And if the microfluidic disc is subsequently rotated, reagents in the pockets will be sequentially released into storage chambers under the effect of the centrifugal force.

In some embodiments, the base is formed in circular or elliptical shape and the material of the base is one selected from the group consisting of wood, plastic, rubber, silicone, resin, fiber, and the combination thereof. The material of the base may also be one selected from the group consisting of methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), urea-formaldehyde (UF), and the combination thereof. On the other hand, the material of the pockets configured on the base may be one selected from the group consisting of wood, plastic, rubber, silicone, resin, fiber, and the combination thereof. In some preferred embodiments, the base and the pockets are formed of the same material. The protrusion member may be a cylinder or a cone formed of one selected from the group consisting of plastic, rubber, silicone, resin, fiber, and the combination thereof. In some preferred embodiments, the base and the protrusion member are formed of the same material. The protrusion member comprises an opening, where the opening is a missed sector of the protrusion member with an angle between 0 and 360 degrees. The angle is preferred to be less than 270 degrees. The angle is further preferred to be less than 180 degrees. The opening is configured to allow reagents to flow into storage chambers.

The cover layer is formed of one selected from the group consisting of foil, plastic, rubber, silicone, resin, fiber, and the combination thereof. The material of the cover layer may also be one selected from the group consisting of methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), urea-formaldehyde (UF), and the combination thereof.

Reagents are preloaded into the pockets on the base respectively. Holes on the pockets are then sealed with the cover layer, made of materials fragile against punchers, to form the reagent package. Positions of the pockets on the base are in accordance with the positions of protrusion members configured at the injection sites of the microfluidic channels on the microfluidic disc. Therefore, once the protrusion members are aligned to the pockets and the reagent package is combined to the microfluidic disc, the protrusion members will punch the cover layer. Similar to a microvalve, the liquid reagents will be retained between the storage chambers and the protrusion members by resistance forces, such as surface tension of liquids, friction from the pockets (associated with the conformation, diameter, and material of pockets), and resistance between the pockets and the storage chambers (associated with the size of the pockets, volume of liquid in the pockets, and the size of the storage chambers).

When the microfluidic disc is rotated, centrifugal force will be generated. The centrifugal force and the weight of liquid are the driving forces to drive the liquids, and the rotational speed required to drive a liquid is greater if the liquid is closer to the center of the base. More particularly, before the microfluidic disc is rotated, resistance forces including the surface tension of the liquids, the resistance between the pockets and the storage chambers, and the friction from the pocket are greater than the driving forces including the centrifugal force and the weight of liquid, and the liquids are therefore retained in the pockets. And once the microfluidic disc is rotated, the driving forces such as the centrifugal force will overcome the resistance forces. The liquid reagents will then be sequentially released into each storage chamber of each microfluidic channel of the microfluidic disc with elevating rotational speed. After the reactions are finished, the reagent package and the microfluidic disc may be discarded as a whole. The disposability of the apparatus with pre-packaged reagents may provide convenience and mitigate possible pollution to environment. The one-time-use feature of the apparatus with pre-packaged reagents may also diminish contamination to and denaturation of the reagents, and therefore provides stable and reliable test results.

### BRIEF DESCRIPTION OF THE DRAWINGS

FIG. 1 is a schematic diagram illustrating a reagent package, according to some embodiments of the present invention.

FIG. 2 is a schematic diagram illustrating the injection sites on a microfluidic disc, according to some embodiments of the present invention.

### DESCRIPTION OF THE PREFERRED EMBODIMENTS

The examples depicted in the following section are provided for the purpose of detailed explanation of the features of preferred embodiments, in order to enable one having ordinary skill in the art to understand the preferred embodiments.

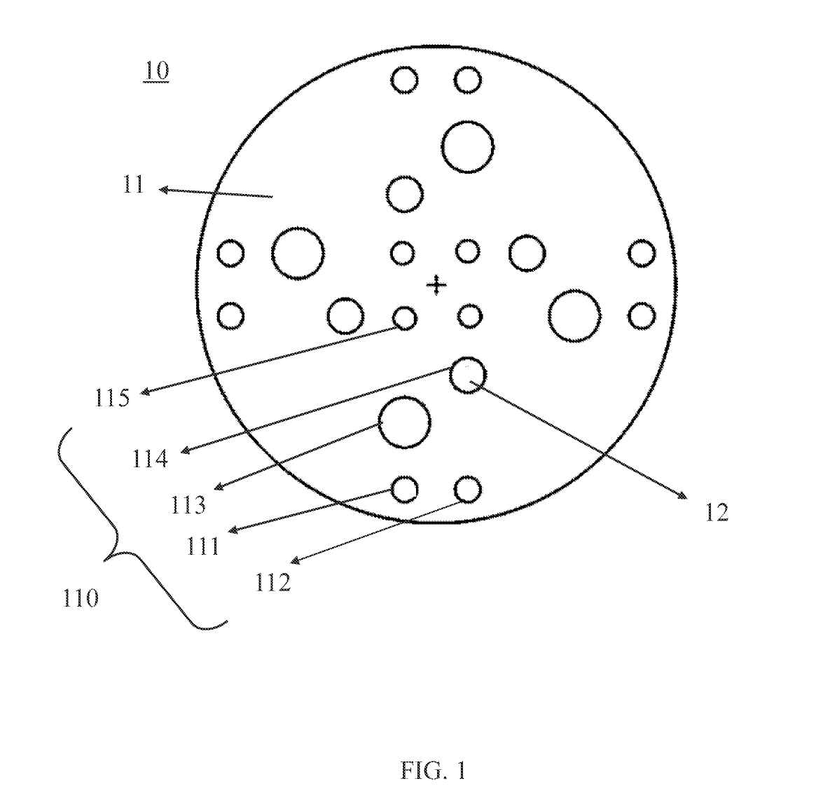

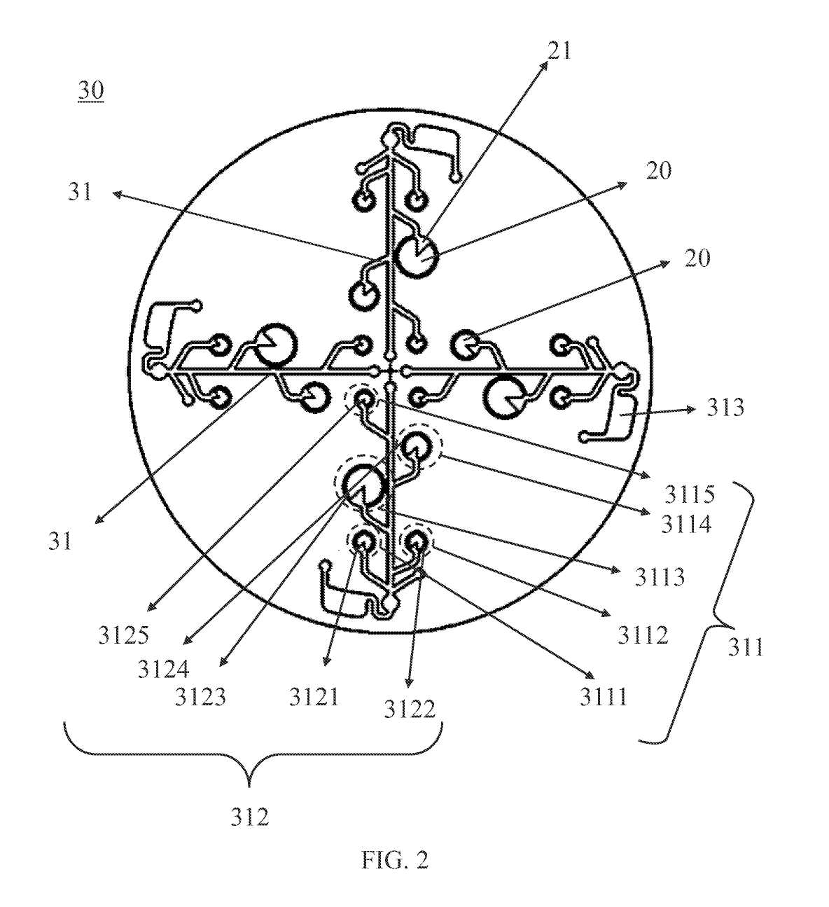

Referring to both FIG. 1 and FIG. 2, in which FIG. 1 is a schematic diagram illustrating a reagent package and FIG. 2 is a schematic diagram illustrating the injection sites on a microfluidic disc. FIG. 1 provides the top view of a reagent package. The reagent package herein is embodied as to perform human chorionic gonadotropin (hCG) testing. The reagent package 10 comprises a round base 11 and a cover layer 12 made of laminated aluminum foil, where the base 11 further comprises four sets of pockets 110. Each set of pockets 110 further comprises a pocket for reagent I 111, a pocket for reagent II 112, a pocket for wash buffer 113, a pocket for developer 114, and a pocket for terminator 115. 20 μL of reagent I (i.e., capture antibodies), 25 μL of reagent II (i.e., detecting antibodies), 120 μL of wash buffer, 80 μL of developer, and 40 μL of terminator are preloaded and sealed into the pocket for reagent I 111, the pocket for reagent II 112, the pocket for wash buffer 113, the pocket for developer 114, and the pocket for terminator 115 with the cover layer 12 respectively. In the embodiments, the base 11 and the pockets 110 are made of polymethyl methacrylate (PMMA).

In some other embodiments, however, the base 11 may be made into circular or elliptical shape. The material of the base 11 may be one selected from the group consisting of methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof, or one selected from the group consisting of wood, plastic, rubber, silicone, resin, fiber, and the combination thereof. In contrast, the pockets 110 may be made of the same material as the base 11 or be one selected from the group consisting of polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof, or one selected from the group consisting of wood, plastic, rubber, silicone, resin, fiber, and the combination thereof. As for the cover layer 12, the material of the cover layer 12 may be selected from the group consisting of one laminated aluminum foil, methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof, one selected from the group consisting of wood, plastic, rubber, silicone, resin, fiber, and the combination thereof, or other materials fragile against punchers.

As illustrated in FIG. 2, the microfluidic disc 30 comprises four microfluidic channels 31, where each microfluidic channel 31 further comprises at least one storage chamber 312. In this embodiment, the at least one storage chamber 312, from periphery to the center of the microfluidic disc 30, is a chamber for reagent I 3121, a chamber for reagent II 3122, a chamber for wash buffer 3123, a chamber for developer 3124, and a chamber for terminator 3125. That is, the five chambers are disposed at different distances relative to the center of the microfluidic disc 30.

As illustrated in FIG. 2, each of the at least one storage chamber 312 comprises an injection site 311. For example, the chamber for reagent I 3121 comprises an injection site 3111, the chamber for reagent II 3122 comprises an injection site 3112, the chamber for wash buffer 3123 comprises an injection site 3113, the chamber for developer 3124 comprises an injection site 3114, and the chamber for terminator 3125 comprises an injection site 3115. Furthermore, the injection sites 3111, 3112, 3113, 3114, 3115 each comprises a protrusion member 20. The protrusion member 20 is a cylinder and is made of methyl methacrylate resin (PMMA). The protrusion member 20 further contains an opening 21, in which the opening 21 is a missed sector has an angle between 0 to 180 degrees in order to allow reagents to flow into the storage chambers 3121, 3122, 3123, 3124, 3125 from the injection sites 3111, 3112, 3113, 3114, 3115 on the storage chambers 3121, 3122, 3123, 3124, 3125 on each microfluidic channel 31. In some other embodiments, the protrusion member 20 may be a cylinder or a cone, and the material of the protrusion member 20 may be one selected from the group consisting of polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof, one selected from the group consisting of wood, plastic, rubber, silicone, resin, fiber, and the combination thereof.

As noted previously, the pockets 111, 112, 113, 114, 115 on the base 11 are disposed in accordance with the positions of the protrusion members 20. Accordingly, the pockets 111, 112, 113, 114, 115 are, from periphery to the center of the base 11, disposed at different distances relative to the center of the base 11.

To load reagents to the microfluidic disc 30, a user may manually or mechanically apply a force to combine the reagent package 10, face down, to the microfluidic disc 30 when the pockets 111, 112, 113, 114, 115 are aligned with the protrusion members 20. The protrusion members 20 will punch through the cover layers 12 upon combined. However, similar to microvalves, the regents will first be retained between the storage chambers 312 and the protrusion members 20 by surface tension of liquids, friction from the pockets 110 (associated with the conformation, diameter, and material of pockets 110), and resistance between the pockets 110 and the storage chambers 312 (associated with the size of the pockets 110, volume of liquid in the pockets 110, and the size of the storage chambers 312).

Before the microfluidic disc 30 is rotated, resistance forces including the surface tension of the liquids, the resistance between the pockets 110 and the storage chambers 312, and the friction from the pocket 110 are greater than the driving forces including the centrifugal force and the weight of the liquids. Similar to a microvalve, the liquids are therefore retained between the pockets 111, 112, 113, 114, 115 and the protrusion members 20 without leaving the pockets 111, 112, 113, 114, 115. Rotation of the microfluidic disc 30 and the weight of liquid are then utilized to enhance the driving forces to overcome the resistance forces. More particularly, the pockets 111, 112, 113, 114, 115 are, from periphery to the center of the base 11, disposed at different distances relative to the center of the base 11, the driving forces required for overcoming is greater for a pocket closer to the center of the base 11. Accordingly, the increasing rotational speed of the microfluidic disc 30 will apply an increasing centrifugal force on reagents, and the reagents will be sequentially released into storage chambers 3121, 3122, 3123, 3124, 3125 from the pockets 111, 112, 113, 114, 115. The reagents will then flow into the detection chambers 313 for reactions. After the reactions are finished, the reagent package 10 and the microfluidic disc 30 may be discarded as a whole. The disposability of the apparatus with pre-packaged reagents may provide convenience and mitigate possible pollution to environment. The one-time-use feature of the apparatus with pre-packaged reagents may also diminish contamination to and denaturation of the reagents, and therefore provides stable and reliable test results.

There are many inventions described and illustrated above. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

What is claimed is:

1. An apparatus with pre-packaged reagents, comprising:
a reagent package, comprising:
a base comprising at least one pocket, wherein the at least one pocket each is configured to store a reagent; and
a cover layer disposed on the at least one pocket, wherein the cover layer is configured to seal the at least one pocket; and
at least one protrusion member having an opening, wherein the at least one protrusion member is disposed at an injection site, and wherein the injection site is located at each storage chamber configured on each microfluidic channel disposed on a microfluidic disc;
wherein the position of the at least one pocket on the base is in accordance with the position of the at least one protrusion member;
wherein the at least one protrusion member is configured to punch through the cover layer when the at least one pocket is aligned and combined with the at least one protrusion member and to sequentially release the reagent in the at least one pocket into the storage chamber by the centrifugal force generated by rotation of the microfluidic disc.

2. The apparatus with pre-packaged reagents as claimed in claim 1, wherein the base comprises multiple pockets disposed at different radial distances relative to the center of the base.

3. The apparatus with pre-packaged reagents as claimed in claim 1, wherein the base is formed in circular or elliptical shape.

4. The apparatus with pre-packaged reagents as claimed in claim 1, wherein the base is formed of one selected from the group consisting of wood, plastic, rubber, silicone, resin, fiber, and the combination thereof.

5. The apparatus with pre-packaged reagents as claimed in claim 1, wherein the at least one pocket is formed of one selected from the group consisting of wood, plastic, rubber, silicone, resin, fiber, and the combination thereof.

6. The apparatus with pre-packaged reagents as claimed in claim 1, wherein the base is formed of one selected from the group consisting of methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof.

7. The apparatus with pre-packaged reagents as claimed in claim 1, wherein the cover layer is formed of one selected from the group consisting of foil, plastic, rubber, silicone, resin, fiber, and the combination thereof.

8. The apparatus with pre-packaged reagents as claimed in claim 1, wherein the cover layer is formed of one selected from the group consisting of methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof.

9. The apparatus with pre-packaged reagents as claimed in claim 1, wherein at least one the protrusion member is a cylinder or a cone.

10. The apparatus with pre-packaged reagents as claimed in claim 1, wherein the at least one protrusion member is formed of one selected from the group consisting of plastic, rubber, silicone, resin, fiber, and the combination thereof.

11. The apparatus with pre-packaged reagents as claimed in claim 1, wherein the at least one protrusion member is formed of one selected from the group consisting of methyl methacrylate resin (PMMA), polycarbonates (PC), polystyrene (PS), polypropylene (PP), polyethylene terephthalate (PET), polyvinyl chloride (PVC), polyvinylidene chloride (PVDC), polyethylene (PE), polycarbonate-ABS (PC-ABS), polyether ether ketone (PEEK), polylactic acid (PLA), high impact polystyrene (HIPS), urea-formaldehyde (UF), and the combination thereof.

12. The apparatus with pre-packaged reagents as claimed in claim 1, wherein the opening is a missed sector of the protrusion member with an angle less than 360 degrees.
